(19) United States
(12) Patent Application Publication
(10) Pub. No.: US 2020/0216182 A1
(43) Pub. Date: Jul. 9, 2020

(54) BLI PROPULSION SYSTEM WITH THREE AFT PROPULSION UNITS

(71) Applicant: Airbus Operations (S.A.S.), Toulouse (FR)

(72) Inventors: Camil Negulescu, Toulouse (FR); Antoine Abele, Toulouse (FR)

(21) Appl. No.: 16/719,020

(22) Filed: Dec. 18, 2019

(30) Foreign Application Priority Data
Dec. 24, 2018 (FR) 1874098

(51) Int. Cl. B64D 27/20; B64D 27/18

(52) U.S. Cl. CPC B64D 27/20; B64D 27/18

(57) ABSTRACT

A propulsion system for an aircraft including a fuselage and a wing assembly. The propulsion system includes a first propulsion device at the level of the rear part of the fuselage and constituted of at least one BLI propulsion unit including a fan, a second propulsion device constituted of at least one conventional propulsion unit, and a transmission device coupling the first and second propulsion devices. The second propulsion system therefore generates the energy necessary for driving in rotation the fan of the BLI propulsion unit or units. The thrust produced by the propulsion devices contributes to generating the total thrust of the aircraft. In this propulsion system at least one conventional propulsion unit constituting the second propulsion device is situated on one side of the rear part of the fuselage between the tail of the fuselage and the wing assembly of the aircraft.

### CROSS-REFERENCE TO RELATED APPLICATION

This application claims priority to French Patent Application No. 1874098, filed Dec. 24, 2018, the entire disclosure of which is incorporated by reference herein.

### TECHNICAL FIELD

The disclosure herein concerns aircraft propulsion systems and more specifically the composition thereof and the layout thereof on an aircraft.

### BACKGROUND

Commercial aircraft most often have a general architecture comprising a fuselage, a wing assembly comprising two wings, and a tail assembly situated on the rear part of the fuselage. Such aircraft further include a propulsion system comprising one or more propulsion units, those most commonly employed being turbojets. The propulsion units can be installed on the aircraft in accordance with various configurations. They are most usually suspended below the wings on support pylons, but may also be fixed to the rear of the fuselage by pylons or at the level of the tail assembly.

When the aircraft moves through the air, its external surfaces influence the flow of air. In particular, when an aerodynamic profile moves in air a boundary layer is created at the surface of that aerodynamic profile. This boundary layer corresponds to a zone in which the speed of the air flow is slowed by the viscosity of the air in contact with the surfaces of the profile.

The propulsion units are generally configured so as not to aspirate this boundary layer forming on the aerodynamic surfaces of the aircraft. To this end the propulsion units are most commonly mounted so that their air intake is situated in a free flow of air, that is to say is little if at all disturbed by the surfaces of the aircraft. This is the case when for example the propulsion units are suspended under the wing assembly or at a distance from the fuselage on the rear part of the aircraft.

However, ingestion of this boundary layer by the propulsion unit has certain advantages, improving the propulsion efficiency of these aircraft and reducing their specific consumption, that is to say the fuel consumption relative to the thrust of the aircraft. In order to profit from these advantages a propulsion unit can therefore be configured to ingest the boundary layer. Such propulsion units are generally designated by the abbreviation BLI standing for “Boundary Layer Ingestion”. One possible configuration of a BLI type propulsion unit on an aircraft is its installation in the rear part of the fuselage.

An example of a BLI propulsion unit installed in the rear part of the fuselage is described in the patent application US-A1-2017/0081034. Hereinafter, where necessary, the relative axial positions of the components of the propulsion system or other constituent elements of the aircraft will be indicated with respect to the direction of the flow of gas through the propulsion units. The aircraft propulsion system described in the prior art document referred to above includes a BLI type propulsion unit installed at the level of the tail of the aircraft and two conventional propulsion units, here turbojets, installed under the wings forming the wing assembly of the aircraft. In this configuration the net or total thrust of the aircraft is the result of adding the thrust of the BLI propulsion unit and the thrust of the two turbojets. The BLI propulsion unit comprises a motor unit mechanically coupled to a fan that it drives in rotation. The motor unit of the BLI propulsion unit is constituted of an electric motor and the fan is situated downstream of the motor unit.

For their part the turbojets comprise a fan connected on the downstream side to the shaft of a gas turbine that forms the heart of the turbojet, the shaft of the gas turbine driving in rotation the fan and an electric generator. Each of the turbojets can drive a generator or, as disclosed in the prior art document referred to above, they may drive mechanically a generator installed in the fuselage at the level of the wings. In that configuration the electric motor of the BLI propulsion unit is fed with electrical energy produced by this generator and a network of electric cables connecting the generator situated at the level of the wings to the electric motor situated in the tail of the fuselage. The transformation of the mechanical energy directly produced by the turbojets into electrical energy and its transportation to the electric motor driving the fan of the BLI propulsion unit leads to a 5 to 10% loss of energy efficiency which considerably reduces the benefits of energy saving resulting from the use of a rear BLI propulsion unit. Moreover, the electrical transmission subsystem constituted by the electric generator, the electric motor and the cables that connect them adds considerably to the weight of the aircraft, which also impacts negatively on fuel consumption and commensurately reduces the benefits expected on installing a BLI propulsion unit.

Replacing electrical transmission by mechanical transmission, which leads to lower energy losses, is not realistic in this configuration because its weight resulting from the long distance separating the wings from the tail of the fuselage would be much too great. Equally unrealistic would be replacing the electric motor with a separate gas turbine to constitute the motor unit of the BLI propulsion unit, because that would add a considerable additional maintenance cost.

### SUMMARY

The object of the disclosure herein therefore consists in or comprises proposing an aircraft propulsion system reducing the fuel consumption of the aircraft propulsion system by optimizing its energy efficiency and optimizing the advantages stemming from the installation in the tail of the fuselage of a BLI propulsion unit.

That object is achieved by the subject matter of the disclosure herein which consists in or comprises a propulsion system of an aircraft comprising a fuselage having a nose and a tail and a wing assembly situated between the nose and the tail of the fuselage, the propulsion system comprising a first propulsion device situated at the level of the tail of the fuselage and constituted of at least one BLI propulsion unit comprising a fan; a second propulsion device constituted of at least one ducted fan turbojet; and a transmission device coupling the first and second propulsion devices in order to transmit some of the energy generated by the second propulsion device to the first propulsion device, so that the second propulsion system generates the energy necessary for driving in rotation the fan of the BLI type propulsion unit. In the propulsion system the thrust produced by the first and second propulsion devices contributes to generating the total thrust of the aircraft.

The aircraft propulsion unit according to the disclosure herein is therefore characterized in that the at least one ducted fan turbojet constituting the second propulsion device is situated at least on one side of the rear part of the fuselage between the tail of the fuselage and the wing assembly of the aircraft and the first propulsion device generates between 20% and 80% of the total thrust of the aircraft.

Arranging the turbojets in the rear part of the fuselage in proximity to the tail where the BLI propulsion unit and its motor unit are installed enables reduction of the distance over which the energy has to be transmitted between the turbojets and the BLI propulsion unit. This disposition leads to a reduction in the weight of the system enabling the transmission of energy from the turbojets to the BLI type propulsion unit and reduction of the energy loss induced by that transmission of energy.

In a particularly advantageous configuration of the aircraft propulsion system according to the disclosure herein the second propulsion device comprises two conventional propulsion units situated on respective opposite sides of the rear part of the fuselage of the aircraft and the first propulsion device comprises a BLI propulsion unit.

In the propulsion system the transmission device is preferably essentially of mechanical type.

More particularly, the transmission device in the propulsion system comprises at least one primary transmission shaft mechanically connected to the second propulsion device and a secondary transmission shaft mechanically connected to the first propulsion device.

The secondary transmission shaft is advantageously mechanically connected by one of its ends to the fan of the BLI propulsion unit; and the transmission device comprises two primary transmission shafts each mechanically connected by one of its ends to one of the conventional propulsion units.

The transmission device additionally integrates at least one safety device interrupting the transmission of mechanical energy in the event of an overload.

A safety device is preferably integrated into each of the primary transmission shafts and secondary transmission shafts and/or at the level of the rotors of the conventional propulsion units.

The fan of the BLI propulsion unit preferably has a diameter between 1.5 and 2.5 m inclusive.

In accordance with a second embodiment of the disclosure herein, an aircraft fuselage rear part includes a propulsion system as described hereinabove.

Each conventional propulsion units is preferably connected to the rear part of the fuselage by a profiled pylon and in which the primary transmission shafts are mounted aft of the pylons and transversely to the general axis of the fuselage.

In accordance with a third embodiment of the disclosure herein, an aircraft comprises a rear fuselage part as described hereinabove.

### BRIEF DESCRIPTION OF THE DRAWINGS

Other features and advantages of the disclosure herein will be highlighted by the following description of nonlimiting embodiments of the various aspects of the disclosure herein. The description refers to the appended figures which are also given by way of example of non-limiting embodiments of the disclosure herein:

FIG. 1 represents a side view in half-section of a BLI propulsion unit;

FIG. 2 represents a view from above of an aircraft including two turbojets and a BLI propulsion unit;

FIG. 3 represents a side view partly in section of an aircraft rear part including a propulsion system according to the disclosure herein;

FIG. 4 represents a view from above in half-section of the rear part of the fuselage with a propulsion system according to the disclosure herein;

FIG. 5 shows an aircraft from above equipped with a propulsion system according to the disclosure herein.

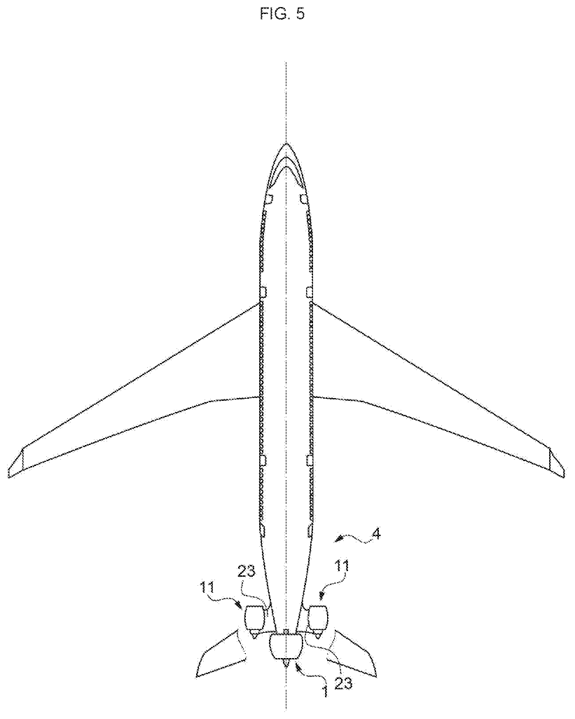

### DETAILED DESCRIPTION

Hereinafter the relative axial positions of the components of the propulsion unit will be indicated relative to the direction of the flow of gas through the propulsion units. An aircraft is conventionally driven by a propulsion system including one or more propulsion units. Those propulsion units are most often turbojets that are generally fixed under the wings of the aircraft. However, aircraft propulsion systems may also include a boundary layer ingestion (BLI) propulsion unit. The most appropriate position for a BLI propulsion unit is at the level of the rear part of the fuselage. In fact, positioning a BLI propulsion unit in the fuselage tail enables the fan thereof to ingest all of or at least a substantial part of the boundary layer of the fuselage with a reduced loss of efficiency of the fan caused by turbulence.

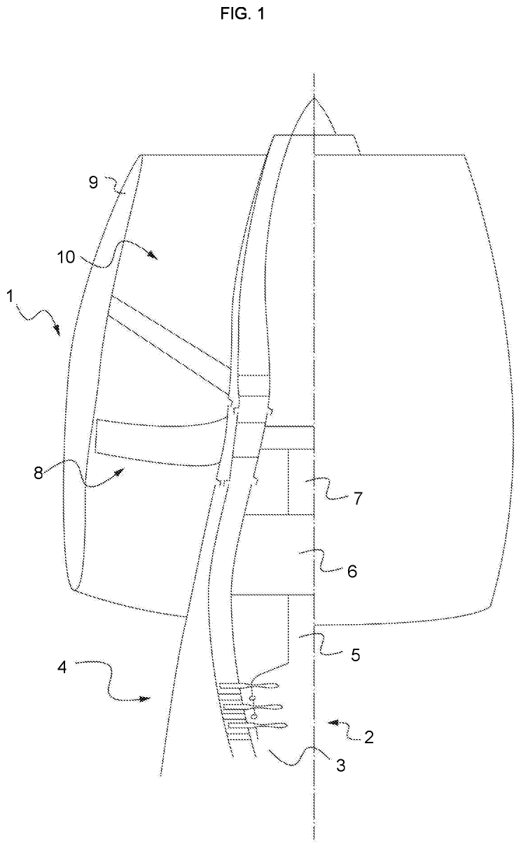

As shown in FIG. 1, when the thrust of an aircraft is produced by a BLI propulsion unit 1, the latter typically includes a motor unit 2 comprising a motor 3 situated in the rear part of the fuselage 4. The motor 3 may be a gas turbine, a turbojet, or any other type of motor such as for example an electric motor. In FIG. 1 the motor 3 is a gas turbine. The motor 3 features a rotor 5 that is generally coupled to a gearbox 6. The output of the gearbox 6 is connected to a fan shaft 7 to drive in rotation a fan 8. The gearbox 6 may be an epicyclic gear train or any other transmission system enabling adaptation of the rotation speed of the fan shaft 7 to that of the rotor 5. In BLI propulsion units 1 mounted in the fuselage tail 4 the motor 3 is also situated in the rear part of the fuselage on the upstream side of the fan 8. The fan 8 is situated downstream of the motor 3 and is housed in a nacelle 9 that features an interior duct 10 into which air is aspirated by the fan 8.

If the aircraft is propelled only by the BLI propulsion unit 1, a gas turbine generates the energy necessary to drive the fan. This gas turbine can be housed either inside the rear part of the fuselage 4 or outside the fuselage. In this kind of configuration, if the rear BLI propulsion unit or the gas turbine that drives it becomes inoperative, the aircraft suffers a total loss of propulsion. On the one hand, if a gas turbine is situated on the exterior of the fuselage, that increases the surface area in contact with the flow of air surrounding the aircraft and therefore its aerodynamic drag. On the other hand, being in a free configuration, the additional turbine is very noisy. Conversely, if the gas turbine is situated inside the fuselage, thermal protection is necessary. This configuration does not solve the safety problems linked to failure of the gas turbine driving the fan of the BLI propulsion unit or to failure of the BLI propulsion unit. Access to the internal gas turbine for maintenance is difficult, and the problems linked to failures of a single propulsion unit are not solved. An additional problem linked to the use of only one BLI propulsion unit to propel the aircraft is its size. To propel a commercial aircraft the size of the propulsion unit becomes considerable with a fan diameter of the order of 3 meters. The size of the rear BLI propulsion unit therefore limits the angle of attack of the aircraft on take-off and therefore its maximum take-off weight.

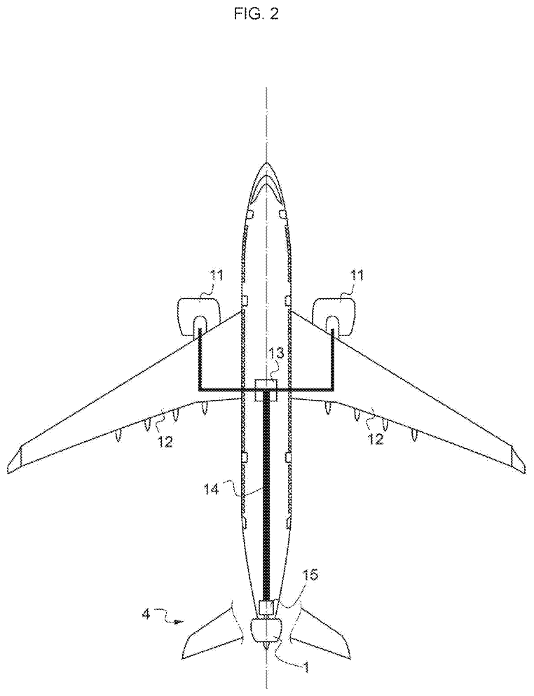

As employed in an aircraft shown in FIG. 2, another BLI propulsion aircraft propulsion system architecture comprises, in addition to a BLI propulsion unit 1 situated in the fuselage tail 4, two conventional propulsion units 11 of turbojet type. Each of these turbojets 11 is situated under a wing 12 and the two generate between 60% and 80% of the thrust of the aircraft. The BLI propulsion unit 1 for its part provides between 20% and 40% of the thrust of the aircraft. In this mixed configuration it is the turbojets 11 that generate the energy necessary to drive in rotation the fan of the BLI propulsion unit 1. Nevertheless, because of the great distance between the turbojets 11 and the BLI propulsion unit 1 the distribution of energy between the turbojets 11 and the BLI propulsion unit 1 is effected by an electrical connection.

As shown in FIG. 2 the rotors of the turbojets 11 are either mechanically coupled to a common electric generator 13 or each connected to a respective electric generator. Power electric wiring 14 connects the electric generator or generators 13 to an electric motor 15 mechanically coupled to the fan of the BLI propulsion unit 1 as described above. The transformation of the mechanical energy of the turbojets into electrical energy and again into mechanical energy leads to an energy loss between 5% and 10% inclusive, which impacts negatively on the overall efficiency of the propulsion system and considerably reduces the benefit of having a BLI propulsion unit to reduce the fuel consumption of the aircraft. Also, the constituent elements of the electric transmission subsystem, that is to say the generator or generators 13, the electric motor 15 and the wiring 14, add a considerable additional weight to the aircraft. The electric generators deliver a constant power to the BLI propulsion unit between the various flight phases, that power being defined by the maximum absorption capacity of the electrical system. Accordingly, in this configuration, none of the three propulsion systems functions optimally between these various flight phases. For all these reasons, these propulsion systems deliver only limited improvements in terms of fuel consumption. In this architecture of the propulsion system replacing electric transmission by mechanical transmission, which would limit the energy losses linked to transmission, is not feasible given the length of the transmission shaft between the wings 12 and the tail of the fuselage 4 and the resulting excessive additional weight. Likewise, adding a separate gas turbine to drive the fan of the BLI propulsion unit in addition to the turbojets 11 not realistic because of the direct increase in maintenance costs that this would lead to.

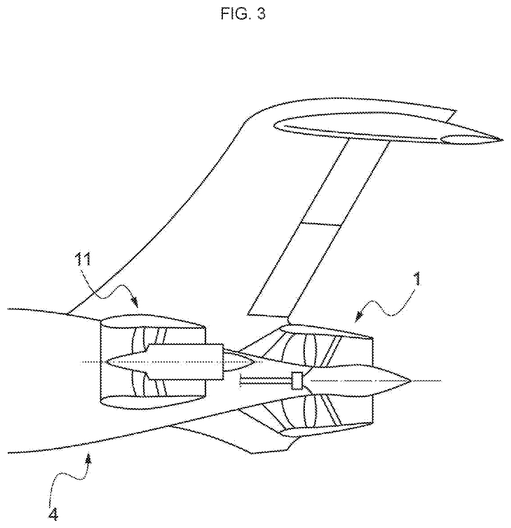

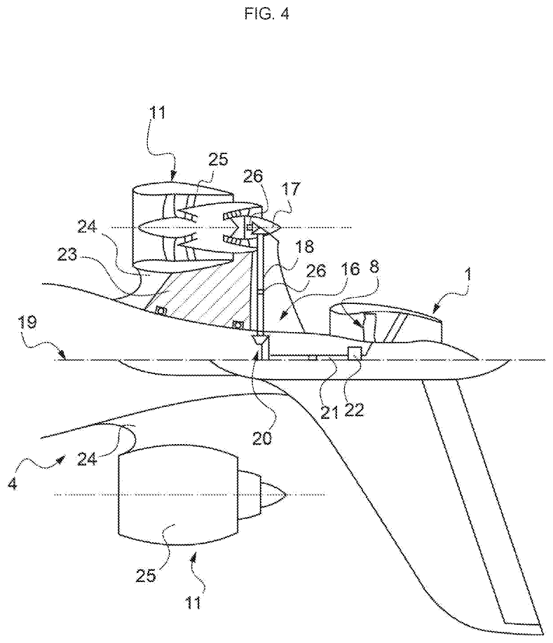

The disclosure herein proposes an alternative to the BLI propulsion system described hereinabove that enables significant reduction of the fuel consumption of the aircraft by optimizing the architecture of the propulsion system comprising a rear BLI propulsion unit. As shown in FIGS. 3 and 4 the propulsion system according to the disclosure herein comprises in addition to a single rear BLI propulsion unit 1 two turbojets 11 situated one on each side of the rear part of the fuselage 4 upstream of the rear BLI propulsion unit 1. The proportion of the thrust provided by the rear BLI propulsion unit 1 is at least one third of the total thrust of the aircraft. The diameter of the fan of the rear BLI propulsion unit 1 is reduced to around 1.75 m rather than 3 m if the BLI propulsion unit provides all the thrust of the aircraft. The reduced size of the BLI propulsion unit allows a greater angle of attack of the aircraft on take-off. The two turbojets 11 have a gas flow bypass between around 5 and 6. A mechanical transmission 16 distributes energy between the turbojets 11 and the rear BLI propulsion unit 1 in order to drive in rotation the fan of the BLI propulsion unit 1.

In this configuration the distribution of the power or of the thrust of the propulsion system between the various propulsion units does not fluctuate greatly between the flight phases of an aircraft on take-off, when climbing, and at cruising speed. The proportion of the total thrust produced by the rear BLI propulsion unit 1 is between 20% and 80% inclusive depending on the required levels of compromise between propulsion efficiency and inclination of the aircraft at take-off, and therefore its maximum weight on take-off, by optimizing the diameter of the rear BLI propulsion unit 1.

Each turbojet 11 is mechanically connected via a primary angle transmission 17 to a transverse shaft 18. These primary angle transmissions 17 may be constituted for example of bevel gears or homokinetic joints. These transverse axes 18 are positioned transversely relative to the longitudinal axis of the aircraft 19 on respective opposite sides of the rear part of the fuselage 4. At the level of the fuselage upstream of the BLI propulsion unit 1 the transverse shafts 18 are mechanically connected to respective opposite sides of a secondary angle transmission 20 that may be constituted of a set of conical gears the output of which is connected to a longitudinal shaft 21 oriented on the axis of the aircraft 19. In its downstream part the longitudinal shaft is mechanically connected to the fan 8 of the rear BLI propulsion unit 1. The fan 8 of the BLI propulsion unit 1 situated in the fuselage tail is connected to the downstream part of the longitudinal shaft 21. A gearbox 22 may be inserted between the longitudinal shaft and the fan. The loss of energy that can be imputed to this mechanical transmission is of the order of only 1%, which is very much lower than the 5 to 10% loss of electrical transmission. Moreover, the weight of the mechanical transmission employed in the propulsion system according to the disclosure herein is between 300 kg and 500 kg inclusive, which is much less than the weight of the electrical transmission described hereinabove.

The weight of the mechanical transmission of the propulsion system according to the disclosure herein is also less than that of the motor unit of a BLI propulsion unit driven by a gas turbine. In fact, in the design concept according to the disclosure herein only a fraction of the total power corresponding to the propulsion of the BLI propulsion unit (that is to say of 33 to 60%) passes through the mechanical transmission. Moreover, the propulsion system according to the disclosure herein is much less noisy than a propulsion system in which the fan of the BLI propulsion unit is driven in rotation by a distinct gas turbine installed outside the fuselage.

In the propulsion system according to the disclosure herein each of the turbojets 11 is fixed to a pylon 23 that connects them to the rear part of the fuselage 4 where they are installed. The transverse transmission shafts 18 are situated aft of and parallel to the pylons 23. The pylons 23 of the turbojets 11 are profiled so that each of them is able to integrate a cowling 24 enclosing the pylons and the transverse transmission shafts 18. This cowling 24 extends transversely to the axis of the fuselage 19 between the rear part of the fuselage 4 and nacelles 25 enclosing the turbojets 11, and longitudinally in front of the pylons 23 and to the rear of the transverse transmission shafts 18. The pylons 23 and the transverse transmission shafts 18 are provided with cowlings in order to reduce the aerodynamic drag of the aircraft.

The fan 8 of the rear BLI propulsion unit 1 is driven by a transmission shaft line 18, 21 connecting it mechanically to the rotor of the turbojets 11. The specific architecture of the propulsion system according to the disclosure herein enables avoidance of total power loss in the event of failure of one of the propulsion units 1 and 11. Thus if one of the turbojets 11 is rendered inoperative for any reason, the turbojet 11 remaining operational continues to deliver its own thrust and to drive the rear BLI propulsion unit 1, which is therefore able to contribute to the total thrust of the aircraft. Likewise, in the event of failure of the rear BLI propulsion unit 1, the two turbojets 11 continue to deliver their own power. In order to isolate one of the propulsion units 1 and 11 in the event of failure thereof and to ensure operational continuity of the remaining propulsion units, one or more safety devices 26 is or are integrated into the transmission chain connecting the rotors of the turbojets 11 to the fan 8 of the rear BLI propulsion unit 1. These safety devices 26 decouple a driving part from a receiving part in the event of overloading a transmission line. They may be integrated with the longitudinal transmission shaft 21 or with each of the transverse transmission shafts 18 or with the three transmission shafts. Independently of or cumulatively with the safety devices 26 for the transmissions shafts 18 and 21, safety devices 26 may be integrated into the rotors of the turbojets 11 and the rear BLI propulsion unit 1.

These safety devices 26 may be selected from known mechanical devices enabling interruption of a transmission line in the event of blockage or of overloading of the motor part or the receiver part interconnected by the transmission line. In the event of an overload these devices enable continuity of operation to be provided and/or prevent damage to the mechanical elements of the devices to be protected. There are various types of safety device that may be divided into two categories. There exist safety devices one component of which is calibrated to break in the event of an overload, for example torque limiters with a shear screw or shaft. In these devices, a mechanical element included in a coupler connecting two parts of a transmission shaft ruptures in the event of an overload. The mechanical connection linking the motor member or a plurality of motor members to one or more receiving members is therefore permanently interrupted until replacement of the ruptured element, which is generally easy. Thus, the failed member is separated from the transmission line, which continues to connect the mechanical members remaining operational. There are also safety devices that can momentarily interrupt a transmission shaft line in the event of the motor member or the receiver member being overloaded. Thus, when the overload disappears the transmission subsystem reverts to normal operation. In some of these safety devices that are intermittent, the transmission of the motor torque is totally interrupted during the overload phase whereas in others a minimum torque continues to be transmitted, which enables elimination of some causes of overload without damaging the receiver such as the fan of the BLI propulsion unit 1 or of the turbojet or turbojets 11.

In all cases the aircraft continues to benefit from a partial thrust that is shared in a constant manner between the propulsion units remaining operational. The aircraft is therefore able to remain operational and maneuverable until it lands.

The combination of advantages procured by the various aspects of the disclosure herein enables a reduction of consumption to be obtained for an aircraft equipped with a propulsion system according to the disclosure herein of approximately 5% compared to an aircraft equipped with a propulsion system comprising two turbojets suspended under the wings as shown in FIG. 2. This fuel saving is primarily achieved thanks to reduced energy losses because of the mechanical transmission between the turbojets and the rear BLI propulsion unit, a lighter transmission line, less fluctuations of the proportion of the thrust of the fan of the BLI propulsion unit between the various flight phases, and the possibility of increasing the BLI effect on the propulsion of the aircraft. To be more specific, the reduction of fuel consumption achieved for an aircraft equipped with a propulsion system according to the disclosure herein in which the rear BLI propulsion unit produces 33% of the total thrust is between 4.1% and 4.6% inclusive compared to an aircraft equipped with a propulsion system as shown in FIG. 2. If the proportion of the thrust produced by the rear BLI propulsion unit is increased to 60% the reduction in fuel consumption can be between 4.9% and 5.4% inclusive.

Although in the above description the particular aspects of the disclosure herein, in particular the use of a compact and essentially mechanical transmission line enabled by the positions of the turbojets 11 close to the BLI propulsion unit 1, have been described in the context of a propulsion system comprising a BLI propulsion unit 1 and two turbojets 11 installed in the rear part of the fuselage, they could be employed in other configurations with other types of propulsion units and a transmission line connecting them different from that described hereinabove.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft propulsion system comprising a fuselage and a wing assembly, the propulsion system comprising:
a first propulsion device situated at a level of a rear part of the fuselage and comprising at least one boundary layer ingestion (BLI) propulsion unit comprising a fan;
a second propulsion device comprising at least one ducted fan turbojet; and
a transmission device coupling the first and second propulsion devices to transmit some of energy generated by the second propulsion device to the first propulsion device, the second propulsion system therefore generating energy necessary for driving in rotation the fan of the at least one BLI propulsion unit, wherein thrust produced by the first and the second propulsion devices contributes to generating total thrust of the aircraft;
wherein the at least one ducted fan turbojet is situated at least on one side of the rear part of the fuselage between a tail of the fuselage, and the wing assembly of the aircraft and the first propulsion device generates between 20% and 80% of total thrust of the aircraft.

2. The propulsion system of claim 1 wherein the second propulsion device comprises two conventional propulsion units situated on respective opposite sides of the rear part of the fuselage of the aircraft and the first propulsion device comprises a BLI propulsion unit.

3. The propulsion system of claim 1 wherein the transmission device is essentially of mechanical type.

4. The propulsion system of claim 3 wherein the transmission device comprises at least one primary transmission shaft mechanically connected to the second propulsion device and a secondary transmission shaft mechanically connected to the first propulsion device.

5. The propulsion system of claim 4 wherein:
the secondary transmission shaft is mechanically connected by one of its ends to the fan of the BLI propulsion unit; and
the transmission device comprises two primary transmission shafts each mechanically connected by one of their ends to one of the conventional propulsion units.

6. The propulsion system of claim 5 wherein a safety device is integrated into each of the primary transmission shaft(s) and secondary transmission shaft and/or at a level of rotors of the propulsion units.

7. The propulsion system of claim 1 wherein the transmission device integrates at least one safety device interrupting transmission of mechanical energy in an event of an overload.

8. An aircraft fuselage rear part comprising a propulsion system comprising a fuselage and a wing assembly, the propulsion system comprising:
a first propulsion device situated at a level of a rear part of the fuselage and comprising at least one boundary layer ingestion (BLI) propulsion unit comprising a fan;
a second propulsion device comprising at least one ducted fan turbojet; and
a transmission device coupling the first and second propulsion devices to transmit some of energy generated by the second propulsion device to the first propulsion device, the second propulsion system therefore generating energy necessary for driving in rotation the fan of the at least one BLI propulsion unit, wherein thrust produced by the first and the second propulsion devices contributes to generating total thrust of the aircraft;
wherein the at least one ducted fan turbojet is situated at least on one side of the rear part of the fuselage between a tail of the fuselage, and the wing assembly of the aircraft and the first propulsion device generates between 20% and 80% of total thrust of the aircraft.

9. The aircraft fuselage rear part of claim 8 wherein the conventional propulsion units are each connected to the rear part of the fuselage by a profiled pylon and wherein the primary transmission shafts are mounted aft of the pylons and transversely to a general axis of the fuselage.

10. An aircraft comprising a fuselage rear part of claim 8.
